(19) United States
(12) Patent Application Publication
(10) Pub. No.: US 2017/0047583 A1
(43) Pub. Date: Feb. 16, 2017

(54) NON-AQUEOUS ELECTROLYTE STORAGE ELEMENT

(71) Applicants: Hisamitsu KAMEZAKI, Kanagawa (JP); Nobuaki ONAGI, Kanagawa (JP); Masaki YOSHIO, Saga (JP)

(72) Inventors: Hisamitsu KAMEZAKI, Kanagawa (JP); Nobuaki ONAGI, Kanagawa (JP); Masaki YOSHIO, Saga (JP)

(21) Appl. No.: 15/307,606

(22) PCT Filed: May 1, 2015
(86) PCT No.: PCT/JP2015/002305

§ 371 Date: Oct. 28, 2016

(30) Foreign Application Priority Data
May 21, 2014 (JP) 2014-105410
Mar. 17, 2015 (JP) 2015-053629

(51) Int. Cl. H01M 4/36; H01G 11/06; H01G 11/62; H01G 11/60; H01M 4/587; H01G 11/28; H01G 11/66; H01M 10/0568; H01M 10/0569; H01M 4/485; H01G 11/34; H01G 11/50

(52) U.S. Cl. CPC H01M 4/366; H01G 11/34; H01G 11/06; H01G 11/62; H01G 11/60; H01G 11/50; H01G 11/28; H01G 11/66; H01M 10/0568; H01M 10/0569; H01M 4/485; H01M 4/587; H01M 2300/0028; H01M 2220/30

(57) ABSTRACT

A non-aqueous electrolyte storage element, which contains a positive electrode; a negative electrode; and a non-aqueous electrolyte, wherein the positive electrode is an electrode, which contains: graphite-carbon composite particles composed of graphite particles and a carbon layer covering the graphite particles, and containing crystalline carbon; and activated carbon, and wherein the positive electrode is capable of accumulating and releasing anions.

### TECHNICAL FIELD

The present invention relates to a non-aqueous electrolyte storage element.

### BACKGROUND ART

Along with reductions in a weight and size of current electronic products, a non-aqueous electrolyte secondary battery having a high energy density has been developed. Moreover, an improvement of battery properties thereof is desired, as applicable fields of the non-aqueous electrolyte secondary battery expand.

The non-aqueous electrolyte secondary battery is composed of at least a positive electrode, a negative electrode, and a non-aqueous electrolyte, in which a lithium salt is dissolved in a non-aqueous solvent. As for the negative electrode, metal and a metal compound (including oxide, and an alloy with lithium) capable of accumulating and releasing metal lithium and lithium ions, and a carbonaceous material are used.

As for the carbonaceous material, for example, cokes, artificial graphite, and natural graphite are proposed. In such a non-aqueous electrolyte secondary battery, a formation of dendrite is suppressed, as lithium is not present therein in a metal state. Therefore, service life and safety of the battery can be improved. Especially a non-aqueous electrolyte secondary battery using a graphite-based carbonaceous material, such as artificial graphite, and natural graphite, has attracted attentions as a secondary battery that can correspond to a demand for a high capacity.

A second type of the positive electrode active material is a material, which inserts and releases mainly only anions into or from a positive electrode, such as a conductive polymer, and a carbonaceous material. Examples thereof include polyaniline, polypyrrole, polyparaphenylene, and graphite.

A battery using this second type of the positive electrode active material is charged by inserting anions, such as PF₆—, and BF₄—, into a positive electrode, and inserting Li⁺ into a negative electrode, and is discharged by releasing BF₄—, or PF₆— from the positive electrode, and releasing Li⁺ from the negative electrode.

As for an example of such a battery, known is a dual carbon cell, where graphite is used as a positive electrode, pitch coke is used as a negative electrode, and a solution, in which lithium perchlororate is dissolved in a mixed solvent of propylene carbonate and ethyl methyl carbonate, is used as an electrolyte.

As for a conventionally known example of a battery where a positive electrode is charged with high voltage, and is discharged, NPL 1 discloses an example of a battery where graphite is used as a positive electrode, a solution, in which LiBF₄ is dissolved in sulfolane, is used as an electrolyte, and lithium is used as a reference electrode, and the battery can be charged up to 5.2 V. However, it is commonly known that the battery has not been able to be charged to the voltage greater than the aforementioned voltage.

Meanwhile, an electric double-layer capacitor using graphite as a positive electrode material and a carbonaceous material as a negative electrode material has an excellent electric capacity and excellent voltage resistance compared to a conventional electric condenser using activated carbon as an electrode (see PTL 1). Moreover, an example where high capacity of a battery is achieved by using titanium oxide as a negative electrode material is disclosed in PTL 2, and an example where a copolymer material is added to a positive electrode of a battery is disclosed in PTL 3.

Under the aforementioned technical background, a development of a non-aqueous electrolyte secondary battery, in which graphite is used for a positive electrode, and lithium titanate is used for a negative electrode, has been actively performed (see PTL 4 to 10).

Furthermore, NPL2 is a literature discussing an influence by adding activated carbon. This literature reports that conductivity and density are changed by adding activated carbon.

Moreover, an invention associated with a lithium secondary battery, to which activated carbon is blended, is applied for a patent (see PTL 11).

It is generally desired to further increase a capacity of a non-aqueous electrolyte storage element.

### CITATION LIST

### Patent Literature

PTL 1: Japanese Patent Application Laid-Open (JP-A) No. 2005-294780

PTL 2: JP-A No. 2008-124012

PTL 3: Japanese Patent (JP-B) No. 3539448

PTL 4: JP-B No. 3920310

PTL 5: JP-B No. 4081125

PTL 6: JP-B No. 4194052

PTL 7: JP-A No. 2006-332627

PTL 8: JP-A No. 2006-332626

PTL 9: JP-A No. 2006-332625

PTL 10: JP-A No. 2008-042182

PTL 11: JP-A No. 2008-112594

### Non Patent Literature

NPL 1: J. Electrochem. Soc., 118,461

NPL 2: The influence of activated carbon on the performance of lithium iron phosphate based electrodes. Electrochimica Acta 76 (2012) p130-136

### SUMMARY OF INVENTION

### Technical Problem

The present invention aims to provide a non-aqueous electrolyte storage element of high capacity.

### Solution to Problem

As the means for solving the aforementioned problems, the non-aqueous electrolyte storage element of the present invention contains:

a positive electrode;

a negative electrode; and

a non-aqueous electrolyte,

wherein the positive electrode is an electrode, which contains: graphite-carbon composite particles composed of graphite particles and a carbon layer covering the graphite particles, and containing crystalline carbon; and activated carbon, and

wherein the positive electrode is capable of accumulating and releasing anions.

### Advantageous Effects of Invention

The present invention can provide a non-aqueous electrolyte storage element of high capacity.

### BRIEF DESCRIPTION OF DRAWINGS

FIG. 1 is a diagram depicting a relationship of a charging capacity of the storage element of Example 1, where Curve A is a discharging curve at the charge termination voltage (4.9 V), Curve B is a discharging curve at the charge termination voltage (5.0 V), and Curve C is a discharging curve at the charge termination voltage (5.2 V), and Curves A, B, and C each illustrate a state where discharging curves from a first cycle to a ninth cycle are superimposed.

FIG. 2 is a diagram depicting a relationship of a charging capacity of the storage element of Comparative Example 1, where Curve D is a discharging curve at the charge termination voltage (4.9V), Curve E is a discharging curve at the charge termination voltage (5.0 V), and Curve F is a discharging curve at the charge termination voltage (5.2 V), and Curves D, E, and F each illustrate a state where discharging curves from a first cycle to a ninth cycle are superimposed.

FIG. 3 is a diagram depicting an X-ray crystal analysis chart of a carboneous material used in Comparative Example 3.

FIG. 4 is a diagram illustrating an outline of a carbon coating device.

### DESCRIPTION OF EMBODIMENTS

### Non-Aqueous Electrolyte Storage Element

The non-aqueous electrolyte storage element of the present invention contains a positive electrode, a negative electrode, and a non-aqueous electrolyte, and may further contain other members, as necessary.

### Positive Electrode

The positive electrode is appropriately selected depending on the intended purpose without any limitation, provided that it contains a positive electrode storage material (a positive electrode active material). Examples of the positive electrode include a positive electrode, in which a positive electrode material containing a positive electrode active material is provided on a positive electrode collector.

A shape of the positive electrode is appropriately selected depending on the intended purpose without any limitation, and examples thereof include a plate shape, and a disc plate.

### Positive Electrode Material

The positive electrode material for use in the present invention is appropriately selected depending on the intended purpose without any limitation, provided that it contains graphite particles and activated carbon. The positive electrode material may further contain a binder, a thickening agent, and a conductive agent, as necessary.

### Positive Electrode Active Material

Examples of the positive electrode active material include cokes, graphite (e.g., artificial graphite, and natural graphite), and a thermal decomposition product of an organic material under various thermal decomposition conditions. Among them, artificial graphite, and natural graphite are particularly preferable. As for a carbonaceous material, moreover, highly crystalline carbonaceous material is preferable. The crystallinity thereof can be evaluated by X-ray diffraction, or Raman spectroscopy. For example, in a powder x-ray diffraction pattern using a CuKα line, an intensity ratio (I₂ₜₕₑₜₐ=22.3 degrees/I₂ₜₕₑₜₐ=26.4 degrees) of (I₂ₜₕₑₜₐ=22.3 degrees) to (I₂ₜₕₑₜₐ=26.4 degrees) is preferably 0.4 or less.

Note that, I₂ₜₕₑₜₐ22.3 is a diffraction peak intensity at 2theta =22.3 degrees, and I₂ₜₕₑₜₐ=26.4 is a diffraction peak intensity at 2theta=26.4 degrees.

The BET specific surface area of the carbonaceous material by nitrogen adsorption is preferably 1 m²/g to 100 m²/g. The average particle diameter (median diameter) of the carbonaceous material determined by a laser diffraction-scattering method is preferably 0.1 micrometers to 100 micrometers.

As for the carbonaceous material of the positive electrode, graphite-carbon composite particles are preferable. The graphite-carbon composite particles are composite particles, in each of which a carbon coating layer, i.e. a carbon layer, is formed on a surface of a graphite particle. Use of the graphite-carbon composite particles in the positive electrode can improve charging and discharging speed.

In a polarized electrode, an electrolyte is adsorbed on a surface of the carbonaceous material to generate an electrostatic capacity. Therefore, it is considered that an increased surface area of the carbonaceous material is effective for increasing the electrostatic capacity. This idea is applied not only to activated carbon, which is naturally porous, but also to non-porous carbon having microcrystalline carbon similar to graphite. The non-porous carbon generates an electrostatic capacity after irreversibly swelling due to first charging (electric field activation). As a result of the first charging, electrolyte ions or a solvent opens up a space between layers, and thus the non-porous carbon theoretically becomes porous.

On the other hand, graphite has the smaller specific surface area and high crystallinity compared to those of the activated carbon or the non-porous carbon. Moreover, the graphite generates an electrostatic capacity from first charging, and swelling hereof at the time of charging is reversible, and the expansion rate thereof is also low. Accordingly, the graphite has characteristics that it does not become porous as a result of electric field activation. In theory, the graphite is a material that is extremely disadvantageous to generate an electrostatic capacity.

As for carbon covering each surface of the graphite particles, crystalline carbon is used. It is particularly preferred that the carbon covering each surface of the graphite particles be crystalline carbon, as a speed for absorbing and releasing ions is improved.

A material, in which surfaces of graphite particles are covered with amorphous carbon or low crystalline carbon, is known in the art, and examples thereof include a composite material where graphite is covered with low crystalline carbon by chemical vapor deposition, a composite material where graphite is covered with carbon having the average interlayer distance d002 of 0.337 nm or greater, and a composite material where graphite is covered with amorphous carbon.

As for a method for covering surfaces of graphite particles with crystalline carbon, chemical vapor deposition using a fluidized-bed reacting furnace is excellent. Examples of organic matter used as a carbon source of chemical vapor deposition include: aromatic hydrocarbon, such as benzene, toluene, xylene, and styrene; and aliphatic hydrocarbon, such as methane, ethane, and propane.

To the fluidized-bed reacting furnace, the aforementioned organic matter is introduced by blending with inert gas, such as nitrogen. A concentration of the organic matter in the mixed gas is preferably 2 mol % to 50 mol %, more preferably 5 mol % to 33 mol %. The temperature for chemical vapor deposition is preferably 850 degrees Celsius to 1,200 degrees Celsius, more preferably 950 degrees Celsius to 1,150 degrees Celsius. By performing chemical vapor deposition under the aforementioned conditions, surfaces of the graphite particles can be uniformly and completely covered with AB planes (i.e., basal surfaces) of crystalline carbon.

An amount of carbon required for forming a carbon layer is different depending on diameters or shapes of the graphite particles, but the amount thereof is preferably 0.1% by mass to 24% by mass, more preferably 0.5% by mass to 13% by mass, and even more preferably 4% by mass to 13% by mass. When the amount thereof is less than 0.1% by mass, an effect of coating cannot be attained. When the amount thereof is greater than 24% by mass, a problem, such as reduction in a charging and discharging capacity, occurs, as a proportion of the graphite reduces.

The graphite particles used as a raw material may be natural graphite or artificial graphite. The specific surface area thereof is preferably 10 m²/g or less, more preferably 7 m²/g or less, and even more preferably 5 m²/g or less. The specific surface area can be determined by the BET method using N₂ or CO₂ as an adsorbing agent.

Moreover, the graphite is preferably highly crystalline graphite. For example, the crystal lattice constant CO of the 002 plane thereof is preferably 0.67 nm to 0.68 nm, more preferably 0.671 nm to 0.674 nm.

Moreover, a half value width of the 002 peak in an X-ray crystal diffraction spectrum thereof using CuKα rays is preferably less than 0.5, more preferably 0.1 to 0.4, and even more preferably 0.2 to 0.3.

When the crystallinity of the graphite is low, the capacity of the electric double-layer capacitor increases irreversibly.

The graphite preferably has appropriate disturbance with graphite layers, and a ratio of the basal plane and the edge plane within a constant range. The disturbance of the graphite layers are, for example, appeared in the analysis result of Raman spectroscopy. As for the preferably graphite, the peak intensity ratio I(1360)/I(1580) of the peak intensity at 1,360 cm⁻¹ I(1360) in the Raman spectrum thereof to the peak intensity at 1,580 cm⁻¹ I(1580) in the Raman spectrum thereof is preferably 0.02 to 0.5, more preferably 0.05 to 0.25, even more preferably 0.1 to 0.2, and particularly preferably about 0.13 to 0.17.

Note that, the aforementioned intensity ratio cannot be achieved when CVD is performed, and the intensity ratio becomes 2.5 or greater. This is probably because the coating carbon has the crystallinity lower than the crystallinity of the base material.

Moreover, the preferably graphite can be determined with the result of X-ray diffraction spectroscopy. Specifically, a ratio (Ib/Ia) of a peak intensity (Ib) of a rhombohedron in the X-ray crystal diffraction spectrum of the preferably graphite to a peak intensity (Ia) of a hexagonal crystal in the spectrum thereof is preferably 0.3 or greater, more preferably 0.35 to 1.3.

Shapes or sizes of the graphite particles are not particularly limited, as long as resulting graphite-carbon composite particles can form a polarizable electrode. For example, flaky graphite particles, compacted graphite particles, or spherical graphite particles can be used. Characteristics and production methods of these graphite particles are known in the art.

A thickness of each flaky graphite particle is typically 1 mm or less, preferably 0.1 mm or less, and the maximum particle length thereof is 100 mm or less, preferably 50 mm or less.

### Flaky Graphite Particles

The flaky graphite particles can be obtained by chemically or mechanically pulverizing natural graphite or artificial graphite.

For example, the flaky graphite particles can be produced by a conventional method, such as a method where natural graphite, or an artificial graphite material (e.g., kish graphite, and highly crystalline thermally-decomposed graphite) is treated with mixed acid of sulfuric acid and nitric acid, followed by heating to obtain swollen graphite, and then the graphite is pulverized with ultrasonic waves, and a method where an intercalational compound of graphite-sulfuric acid obtained by electrochemically oxidizing graphite in sulfuric acid, or an intercalational compound of graphite-organic matter is rapidly heated by an externally heated furnace, an internally heated furnace, or a laser to swollen the graphite, followed by pulverizing the graphite.

Moreover, the flaky graphite can be obtained by mechanically pulverizing natural graphite or artificial graphite, for example, by means of a jet mill.

The flaky graphite particles are obtained, for example, by forming natural graphite or artificial graphite into flakes or particles. Examples of a method for forming flakes or particles from the graphite include a method where natural graphite or artificial graphite is mechanically or physically pulverized with ultrasonic waves, or by any of various pulverizers.

In the present specification, the graphite particles, which is obtained by pulverizing natural graphite or artificial graphite to turn into flakes by means of a pulverizer that does not apply shear, such as a jet mill, are called flake graphite particles. Meanwhile, the graphite particles, which are obtained by pulverizing swollen graphite with ultrasonic waves to turn into flakes, are called foliated graphite.

The flaky graphite particles may be subjected to annealing in an inert atmosphere at 2,000 degrees Celsius to 2,800 degrees Celsius for about 0.1 hours to about 10 hours, to further enhance crystallinity thereof.

### Compacted Graphite Particles

The compacted graphite particles are graphite particles having high bulk density, and the tap density thereof is typically 0.7 g/cm³ to 1.3 g/cm³. In the present specification, the compacted graphite particles means graphite particles containing spindle-shaped graphite particles having an aspect ratio of 1 to 5, in an amount of 10% by volume or greater, or graphite particles containing disc-shaped graphite particles having an aspect ratio of 1 to 10 in an amount of 50% by volume or greater.

The compacted graphite particles can be produced by forming raw material graphite particles into compacts.

As for the raw material graphite particles, natural graphite or artificial graphite may be used. Use of natural graphite is however preferable because of high crystallinity thereof and readily availability. The graphite can be pulverized as it is to provide raw material graphite particles. However, the aforementioned flaky graphite particles may be used as the raw material graphite particles.

The compact treatment is carried out by applying impulse to the raw material graphite particles. The compact treatment using a vibration mill is more preferable, as the density of the compacted graphite particles can be increased. Examples of the vibration mill include a vibration ball mill, a vibration disk mill, and a vibration rod mill.

When the scaly raw material graphite particles having a large aspect ratio is subjected to a compact treatment, the raw material graphite particles are mainly two-dimensionally formed into particles with laminating at basal planes of the graphite. At the same time, edges of the laminated two-dimensional particles are rounded to turn particles into disc-shaped thick particles having an aspect ratio of 1 to 10, spindle-shaped particles having an aspect ratio of 1 to 5. In this manner, the graphite particles are turned into graphite particles having a small aspect ratio.

By turning the graphite particles into graphite particles having a small aspect ratio in the aforementioned manner, graphite particles having excellent isotropy, and high tap density can be attained with high crystallinity.

In the case where the obtained graphite-carbon composite particles are formed into a polarized electrode, therefore, a graphite concentration in graphite slurry can be made high, and a resulting electrode has a high graphite concentration.

### Spherical Graphite Particles

The spherical graphite particles can be obtained by collecting flakes while pulverizing highly crystalline graphite by means of an impulsive pulverizer giving relatively small pulverization force, to form into spherical compacts. As for the impulsive pulverizer, for example, a hummer mill, or a pin mill can be used. The outer peripheral linear velocity of the rotating hummer or pin is preferably about 50 m/sec to about 200 m/sec. Moreover, the graphite can be supplied to or discharged from the pulverizer with a flow of gas, such as air.

A degree of sphericity of the graphite particles can be represented by a ratio (major axis/minor axis) of a major axis of the particle to a minor axis of the particle. Specifically, when the graphite particle having the maximum value of (major axis/minoraxis) among axis crossed at a center on an arbitral cross-section thereof is selected, the particle is close to sphere, as the value of the ratio is closer to 1. The ratio (major axis/minor axis) can be easily made 4 or less (preferably 1 to 4) by the spheroidizing. Moreover, the ratio (major axis/minor axis) can be made 2 or less (preferably 1 to 2) by sufficiently performing the spheroidizing.

The highly crystalline graphite is graphite obtained by laminating large number of AB planes horizontally spreading with forming a network structure with carbon particles to increase a thickness, and growing in form of a bulk. The bonding force between the laminated AB planes (binding force in a C-axis direction) is slightly smaller than the binding force within the AB plane. As the graphite is pulverized, therefore, flaking of the AB plane having a weak bonding force is carried out preferentially, and therefore obtained particles tend to be in the form of flakes. The stripe shape lines indicating the laminate structure can be observed when a cross-section perpendicular to the AB planes of the graphite crystals is observed under an electron microscope.

The internal structure of the flake graphite is simple. As a cross-section thereof perpendicular to the AB plane is observed, the stripe-shaped lines indicating the laminate structure is always straight lines, and the structure thereof is a plate-shaped laminate structure.

On the other hand, the internal structure of the spherical graphite particle is significantly complex. The stripe-shaped lines indicating the laminate structure are often curves, and voids are often observed. Specifically, a spherical shape is formed, as of flake (plate-shaped) particle is folded, or rounded.

In this manner, a change where an originally linear laminate structure is changed to a curved structure by compression or the like is called “folding.”

Another characteristic of the spherical graphite particles is that a surface area of the particle has a curved laminate structure corresponding to a roundness of the surface even on a randomly selected cross-section thereof. Specifically, a surface of the spherical graphite particle is covered with the substantially folded laminate structure, and the outer surface is composed of the AB planes (i.e., basal planes) of the graphite crystals.

The positive electrode containing the graphite-carbon composite particles can be produced using the graphite-carbon composite particles as the carbonaceous material, in the same manner as a conventional method.

In order to produce a sheet-shaped polarized electrode, for example, after adjusting the granularity of the graphite-carbon composite particles, conductivity adjuvant for giving electroconductivity to the graphite-carbon composite particles, and a binder are added as necessary, and a resulting mixture is kneaded, and is then shaped into a sheet by rolling.

As for the conductivity adjuvant, for example, carbon black, or acetylene black can be used. As for the binder, for example, polyvinylidene fluoride (PVDF), polytetrafluoroethylene (PTFE), polyethylene (PE), or polypropylene (PP) can be used.

In the present invention, moreover, activated carbon is used as a carboneous electrode.

The activated carbon is amorphous carbon having an extremely large specific surface area, as it has numerous fine pores. In the present specification, amorphous carbon having a specific surface area of about 1,000 m²/g or greater is referred to as activated carbon.

In the case where the activated carbon is used as an electrode member, the activated carbon is blended with other components, and the mixture is formed into a layer by backing with a metal sheet or a metal foil. Electricity is introduced to the layer through the metal sheet or metal foil, and is extracted from the layer. As a result of the conduction, the layer of the activated carbon is polarized within the layer to thereby generate an electrostatic capacity. An electrode, which generates an electrostatic capacity as a result of polarization, such as the layer of the activated carbon, is called a polarized electrode. Moreover, a conducting member supporting a polarized electrode is called a collector.

As for the carbonaceous material, a non-porous carbonaceous material containing microcrystalline carbon similar to the graphite and having the smaller specific surface area compared to the activated carbon may be also used.

It is assumed that the non-porous carbonaceous material form an electric double layer, as electrolyte ions are inserted together with a solvent between layers of microcrystalline carbon similar to the graphite, when voltage is applied.

An electric double layer capacitor, which is composed by immersing a non-porous carbonaceous electrode in an organic electrolyte, has been known. The organic electrolyte needs to have ion conductivity, and a solute thereof is a salt formed by bonding cations and anions. Examples of the cation include lower aliphatic quaternary ammonium, lower aliphatic quaternary phosphonium, and imidazorium. Examples of the anion include tetrafluoroboric acid, and hexafluorophosphoric acid. A solvent of the organic electrolyte is a polar aprotic organic solvent. Specific examples thereof include ethylene carbonate, propylene carbonate, gamma-butyrolactone, and sulfolane.

The non-porous carbonaceous electrode has an electrostatic capacity a few times the capacity of the porous electrode composed of the activated carbon, but is irreversibly swollen at a high ratio at the time of an electric field activation. When the carbonaceous electrode is swollen, a volume of a capacitor itself increases, thus an electrostatic capacity per unit volume is reduced. Therefore, it is difficult to sufficiently increase an energy density of the capacitor.

Moreover, the activated carbon or non-porous carbon generates an electrostatic capacity only when an activation treatment, such as heating at high temperature in the presence of alkali metal ions (e.g., sodium, and potassium) (alkali activation), and performing initial charging (electric field activation), is performed. Therefore, there is a risk in the process for producing a carbonaceous electrode from non-porous carbon or the like, and the process thereof is complicated, and costly.

In a polarized electrode, an electrolyte is adsorbed on a surface of the carbonaceous material to generate an electrostatic capacity. Therefore, it is considered that an increased surface area of the carbonaceous material is effective for increasing the electrostatic capacity.

This idea is applied not only to activated carbon, which is naturally porous, but also to non-porous carbon having microcrystalline carbon similar to graphite. The non-porous carbon generates an electrostatic capacity after irreversibly swelling due to first charging (electric field activation). As a result of the first charging, electrolyte ions or a solvent opens up a space between layers, and thus the non-porous carbon theoretically becomes porous.

On the other hand, graphite has the smaller specific surface area and high crystallinity compared to those of the activated carbon or the non-porous carbon. Moreover, the graphite generates an electrostatic capacity from first charging, and swelling hereof at the time of charging is reversible, and the expansion rate thereof is also low. Accordingly, the graphite has originally a small specific surface area, and has characteristics that it does not become porous as a result of electric field activation. The blending ratio of the non-porous carbon, the conductivity adjuvant, and the binder is preferably 10 to 1:0.5 to 10:0.5 to 0.25.

In the storage element of the present invention, anions are intercalated to the positive electrode. The degree of this intercalation is increased by electrostatic suction exhibited by the activated carbon, as the activated carbon is contained in the positive electrode. This phenomenon has not been studied in connection with a capacitor, as the phenomenon indicates a degree of intercalation. Since intercalation of Li⁺ is typically discussed in connection with a battery, there is no discovery or invention associated with an effect of electrostatic suction due to a positive polarity caused by intercalation of BF₄— or PF₆—.

### Binder

The binder is appropriately selected depending on the intended purpose without any limitation, provided that it is a material stable to a solvent or electrolyte used for producing an electrode. Examples thereof include a fluorobinder (e.g., polyvinylidene fluoride (PVDF), and polytetrafluoroethylene (PTFE)), styrene-butadiene rubber (SBR), and isoprene rubber. These may be used alone, or in combination.

### Thickening Agent

Examples of the thickening agent include carboxymethyl cellulose, methyl cellulose, hydroxymethyl cellulose, ethyl cellulose, polyvinyl alcohol, oxidized starch, starch phosphate, and casein. These may be used alone, or in combination.

### Conductive Agent

Examples of the conductive agent include a metal material (e.g., copper, and aluminum), and a carbonaceous material (e.g., carbon black, and acetylene black). These may be used alone, or in combination.

### Positive Electrode Collector

A material, shape, size, and structure of the positive electrode collector are appropriately selected depending on the intended purpose without any limitation.

As for the material, the positive electrode collector may be formed of a conductive material. Examples thereof include stainless steel, nickel, aluminium, copper, titanium, and tantalum. Among them, stainless steel, and aluminium are particularly preferable. Examples of the shape thereof include a sheet shape, and a mesh shape. The size thereof is not limited, as long as it is a size usable for a non-aqueous electrolyte storage element.

### Production Method of Positive Electrode

The positive electrode can be produced by applying a positive electrode material, which is prepared by adding a binder, a thickening agent, a conductive agent, and a solvent, as necessary, to the positive electrode active material to form into slurry, on the positive electrode collector, followed by drying.

The solvent is appropriately selected depending on the intended purpose without any limitation, and the solvent may be an aqueous solvent, or an organic solvent. Examples of the aqueous solvent include water, and alcohol. Examples of the organic solvent include N-methylpyrrolidone (NMP), and toluene.

Note that, the positive electrode active material may be subjected to roll molding as it is to form a sheet electrode, or to compression molding to form a pellet electrode.

### Negative Electrode

The negative electrode is appropriately selected depending on the intended purpose without any limitation, provided that it contains a negative electrode active material. Examples thereof include an electrode, in which a negative electrode material containing a negative electrode active material is provided on a negative electrode collector.

A shape of the negative electrode is appropriately selected depending on the intended purpose without any limitation, and examples thereof include a plate shape.

### Negative Electrode Material

Other than the negative electrode active material, the negative electrode material may contain a binder, and a conductive agent, as necessary.

### Negative Electrode Active Material

The negative electrode active material is appropriately selected depending on the intended purpose without any limitation, provided that it is capable of accumulating and releasing metal lithium, or lithium ions, or both. Examples thereof include a carbonaceous material, metal oxide capable of accumulating and releasing lithium (e.g., tin oxide, antimony-doped tin oxide, silicon monoxide, and vanadium oxide), metal capable of forming an alloy with lithium (e.g. aluminium, tin, silicon, antimony, lead, arsenic, zinc, bismuth, copper, nickel, cadmium, silver, gold, platinum, palladium, magnesium, sodium, potassium, and stainless steel), an alloy containing the aforementioned metal (including a intermetallic compound), a composite alloy compound of a metal capable of forming an alloy with lithium, an alloy containing the aforementioned metal, and lithium, metallic lithium nitride (e.g. lithium cobalt nitride), and lithium titanate. These may be used alone, or in combination. Among them, particularly preferred are a carbonaceous material, and lithium titanate in view of safety and a cost.

Examples of the carbonaceous material include cokes, graphite (e.g., artificial graphite, and natural graphite), and a thermal decomposition product of an organic material under various thermal decomposition conditions. Among them, particularly preferred are artificial graphite and natural graphite. The BET specific surface area of the carbonaceous material (e.g. graphite) as the negative electrode material is preferably 0.5 m²/g to 25.0 m²/g. The average particle diameter (median diameter) of the carbonaceous material determined by a laser diffraction-scattering method is typically preferably 1 micrometers to 100 micrometers.

Moreover, the graphite-carbon composite particles used for the positive electrode can be also used.

### Binder

The binder is appropriately selected depending on the intended purpose without any limitation. Examples thereof include a fluorobinder (e.g., polyvinylidene fluoride (PVDF), and polytetrafluoroethylene (PTFE)), ethylene-propylene-butadiene rubber (EPBR), styrene-butadiene rubber (SBR), isoprene rubber, and carboxymethyl cellulose (CMC). These may be used alone, or in combination.

Among them, a fluorobinder, such as polyvinylidene fluoride (PVDF), and polytetrafluoroethylene (PTFE), is particularly preferable.

### Conductive Agent

Examples of the conductive agent include a metal material (e.g., copper, and aluminium), and a carbonaceous material (e.g., carbon black, and acetylene). These may be used alone, or in combination.

### Negative Electrode Collector

A material, shape, size, and structure of the negative electrode collector are appropriately selected depending on the intended purpose without any limitation.

A material of the negative electrode collector is not particularly limited, as long as it is formed of a conductive material. Examples thereof include stainless steel, nickel, aluminium, and copper. Among them, stainless steel, and copper are particularly preferable.

Examples of a shape of the collector include a sheet shape, and a mesh shape.

A size of the collector is not limited, as long as it is a size usable for a non-aqueous electrolyte storage element.

As for a material of the negative electrode collector, lithium titanate may be used. Lithium titanate is represented by the general formula: LixTiyO₄ (x is equal to or greater than 0.8 but equal to or less than 1.4, and y is equal to or greater than 1.6 but equal to or less than 2.2). As x-ray diffraction is performed on lithium titanate using Cu as a target, there are peaks at least 4.84 angstroms, 2.53 angstroms, 2.09 angstroms, 1.48 angstroms (each plus or minus 0.02 angstroms). Moreover, it is preferred that lithium titanate have the peak intensity ratio (the peak intensity at 4.84 angstroms: the peak intensity at 1.48 angstroms (each plus or minus 0.02 angstroms)) of 100:30 (plus or minus 10).

Moreover, preferred lithium titanate is the one represented by the general formula LixTiyO₄, where x=1, and y=2, or x=1.33, and y=1.66, or x=0.8, and y=2.2.

In the case where rutile crystals of titanium oxide are present together with the lithium oxide, moreover, there are peaks at 3.25 angstroms, 2.49 angstroms, 2.19 angstroms, 1.69 angstroms (each plus or minus 0.02 angstroms) in addition to the peaks of the lithium titanate in the X-ray diffraction spectrum thereof.

Moreover, it is preferred that lithium titanate have the peak intensity ratio (the peak intensity at 3.25 angstroms: the peak intensity at 2.49 angstroms: the peak intensity at 1.69 angstroms of 100:50 (plus or minus 10):60 (plus or minus 10).

Moreover, preferred lithium titanate is the one represented by the general formula LixTiyO₄, where x=1, and y=2, or x=1.33, and y=1.66, or x=0.8, and y=2.2.

Meanwhile, a production method of the negative electrode of the lithium storage element using the aforementioned lithium titanate contains a step where a lithium compound and titanium oxide are blended, and a step where the mixture is subjected to a thermal treatment at 800 degrees Celsius to 1,600 degrees Celsius, to calcinate the lithium titanate. As for the lithium compound, which is a starting material of calcination, lithium hydroxide or lithium carbonate is used.

The temperature of the thermal treatment is more preferably 800 degrees Celsius to 1,100 degrees Celsius.

### Production Method of Negative Electrode

A method for producing the negative electrode is not particularly limited. For example, the negative electrode can be produced by applying slurry, which is prepared by adding a binder, a thickening agent, a conductive agent, and a solvent, as necessary, to the negative electrode active material, onto a substrate of a collector, followed by drying.

As for the solvent, the same solvent used in the production method of the positive electrode can be used.

Also, a binder, and/or a conductive agent is added to the negative electrode active material. This is gen subjected to roll molding as it is to form a sheet electrode, or to compression molding to form a pellet electrode. Alternatively, a thin film of the negative electrode active material may be formed on the negative electrode collector by vapor deposition, sputtering, or plating.

### Non-Aqueous Electrolyte

The non-aqueous electrolyte is an electrolyte, in which an electrolyte salt is dissolved in a non-aqueous solvent.

### Non-Aqueous Solvent

As for the non-aqueous solvent, an aprotic organic solvent is used, but the solvent is preferably a low viscous solvent. Examples thereof include a chain- or cyclic carbonate-based solvent, a chain- or cyclic ether-based solvent, and a chain- or cyclic ester-based solvent.

Examples of the chain carbonate-based solvent include dimethyl carbonate (DMC), diethyl carbonate (DEC), and methyl ethyl carbonate.

Examples of the cyclic carbonate-based solvent include propylene carbonate (PC), ethylene carbonate (EC), butylene carbonate (BC), and vinylene carbonate (VC).

Examples of the chain ether-based solvent include 1,2-dimethoxyethane (DME), diethyl ether, ethylene glycol dialkyl ether, diethylene glycol dialkyl ether, triethylene glycol dialkyl ether, and tetraethylene glycol dialkyl ether.

Examples of the cyclic ether-based solvent include tetrahydrofuran, alkyl tetrahydrofuran, alkoxy tetrahydrofuran, dialkoxy tetrahydrofuran, 1,3-dioxolane, alkyl-1,3-dioxolane, and 1,4-dioxolane.

Examples of the chain ester-based solvent include alkyl propionate, dialkyl malonate, and alkyl acetate.

Examples of the cyclic ester-based solvent include gamma-butyrolactone (gammaBL), 2-methyl-gamma-butyrolactone, acetyl-gamma-butyrolactone, and gamma-valerolactone.

Among them, the non-aqueous electrolyte preferably contain propylene carbonate (PC) as a main component, in an amount of 80% by mass or greater, more preferably 90% by mass or greater.

### Electrolyte Salt

As an electrolyte salt, used is an electrolyte salt that is dissolved in the non-aqueous solvent, and exhibits high ion conductivity.

Examples thereof include a combination of the following cations and anions, but any of various electrolyte salts that can be dissolved in the non-aqueous solvent.

Examples of the cation include alkali metal ions, alkali earth metal ions, tetraalkyl ammonium ions, and spiro quaternary ammonium ions.

Examples of the anion include Cl—, Br—, I—, SCN—, ClO₄—, BF₄—, PF₆—, SbF₆ —, CF₃SO₃—, (CF₃SO₂)₂N—, (C₂F₅SO₂)₂N—, and (C₆H₅)₄B—.

As for the electrolyte salt, lithium salt containing lithium cations is preferable in view of an improvement of a capacity.

The lithium salt is appropriately selected depending on the intended purpose without any limitation, and examples thereof include lithium hexafluorophosphate (LiPF₆), lithium perchlorate (LiClO₄), lithium chloride (LiCl), lithium fluoroborate (LiBF₄), LiB(C₆H₅)₄, lithium hexafluoroarsenate (LiAsF₆), lithium trifluoromethane sulfonate (LiCF₃SO₃), lithium bis(trifluoromethylsulfonyl)imide [LiN(C₂F₅SO₂)₂], and lithium bis(perfluoroethylsulfonyl)imide [LiN(CF₂F₅SO₂)₂]. These may be used alone, or in combination. Among them, LiPF₆ and LiBF₄ are preferable, and LiBF₄ is particularly preferable.

A concentration of the lithium salt in the non-aqueous solvent is appropriately selected depending on the intended purpose without any limitation, but the concentration thereof is preferably 0.5 mol/L to 6 mol/L, more preferably 2 mol/L to 4 mol/L in view of both a capacity and output of the storage element.

### Separator

The separator is provided between the positive electrode and the negative electrode in order to prevent short-circuit between the positive electrode and the negative electrode.

A material, shape, size, and structure of the separator are appropriately selected depending on the intended purpose without any limitation.

Examples of the separator include paper (e.g., kraft paper, vinylon blended paper, and synthetic pulp blended paper), polyolefin non-woven fabric (e.g., cellophane, polyethylene graft membrane, polypropylene melt-blown non-woven fabric), polyamide non-woven fabric, and glass fiber non-woven fabric.

Examples of a shape of the separator include a sheet shape.

A size of the separator is not limited, as long as it is usable for a non-aqueous electrolyte storage element.

A structure of the separator may be a single layer structure, or a laminate structure.

### Production Method of Non-Aqueous Electrolyte Storage Element

The storage element of the present invention can be produced by appropriately assembling the positive electrode, the negative electrode, the non-aqueous electrolyte, and the optionally used separator into an appropriate shape. Moreover, it is also possible to use other constitutional members, such as an exterior case, as necessary. A method for assembling the battery is appropriately selected from methods typically used without any limitation.

### Shape

A shape of the storage element of the present invention is appropriately selected from various shapes typically used depending on the intended purpose without any limitation. Examples of the shape thereof include a cylinder-shaped battery where a sheet electrode and a separator are spirally provided, a cylinder-shaped battery having an inside-out structure, in which a pellet electrode and a separator are used in combination, and a coin-shaped battery, in which a pellet electrode and a separator are laminated.

When the concentration of the solute in the electrolyte is reduced to 0 by charging, the storage element cannot be charged any more. Therefore, an amount of the solute, which counterbalances the capacities of the positive electrode, and the negative electrode, needs to be dissolved in the electrolyte. In the case where the concentration of the solute is low, a large amount of the electrolyte is required in the storage element. Therefore, the concentration of the solute in the electrolyte is preferably high. Depending on a case, it is also possible to leave a state where the solute is precipitated in the solvent, when discharged.

In the aforementioned view, the concentration of the lithium salt in the non-aqueous electrolyte is preferably 0.05 mol/L to 5 mol/L, more preferably 0.5 mol/L to 4 mol/L, and even more preferably 1 mol/L to 3 mol/L. When the concentration thereof is lower than 0.05 mol/L, the conductivity may be low, or the energy density of the storage element per weight or volume tends to be low, as a large amount of the electrolyte is required to secure the solute counterbalances the capacities of the positive electrode and the negative electrode. When the concentration thereof is higher than 5 mol/L, the solute may be precipitated, or the conductivity may be low.

### Aging of Storage Element

The storage element of the present invention may be subjected to aging. As for the method thereof, charging and discharging are performed the predetermined time so that the capacity is to be 100% SOC (SOC=100%) or greater, which is arbitrarily set.

In the case where a battery composed of a positive electrode and a negative electrode is charged, moreover, the same effect can be obtained by changing charge termination voltage depending on a type of the negative electrode, setting charge termination voltage of the positive electrode to the predetermined voltage when lithium is used as a reference electrode, and specifying a charge method in a manner that the charge state of the charge terminal of the positive electrode is to be in the predetermined state. When the charging speed (rate) is too fast, the charge termination voltage is reached before the positive electrode and the negative electrode are sufficiently charged. Therefore, a sufficient capacity cannot be attained. In the case where the charging is performed with constant electric current, charging is preferably performed at the charging speed of typically 1C (1C is a value of electric current with which a rated capacity according to a discharge capacity at hourly rate is discharged over 1 hour). When the charging speed is significantly slow, however, it takes a long time to charge. In the case charge is performed with constant electric current, therefore, the charging speed is preferably 0.01C or greater.

Note that, it is also possible to charge with maintaining the voltage after reaching the charge termination voltage.

When the temperature of the battery is excessively high during charging, decomposition of the nonaqueous electrolyte tends to occur. When the temperature of the battery is excessively low during charging, the positive electrode and the negative electrode tend to be insufficiently charged. Therefore, charging is typically performed at around room temperature.

A discharging method of the storage element of the present invention obtained by being charged in the aforementioned manner varies depending on a discharging sped, or a type of the negative electrode for use. A rating discharge capacity is substantially attained by performing discharge from the charged state typically at the discharging speed of 1C or less, using the value of about 2 V to about 3 V as discharge termination voltage. For example, the discharge capacity per positive electrode active material is preferably 60 mAh/g or greater, more preferably 80 mAh/g to 120 mAh/g.

### Use

The non-aqueous electrolyte storage element of the present invention is used, for example, as a non-aqueous electrolyte secondary battery, or a non-aqueous electrolyte capacitor.

Use of the non-aqueous electrolyte storage element is not particularly limited, and the non-aqueous electrolyte storage element can be used for various use. Examples thereof include a power source, and a back-up power source of a laptop computer, a stylus-operated computer, a mobile computer, an electronic book player, a mobile phone, a mobile fax, a mobile copier, a mobile printer, a headphone stereo, a video movie, a liquid crystal television, a handy cleaner, a portable CD player, a minidisc player, a transceiver, an electronic organizer, a calculator, a memory card, a mobile tape recorder, a radio, a motor, lighting equipment, a toy, game equipment, a clock, a strobe, or a camera.

The present invention is more specifically explained through examples hereinafter, but the present invention is not limited to these examples. Note that, charge termination voltage of a positive electrode using lithium as a reference electrode in the examples is referred to as “charge termination voltage (vs. Li).” Moreover, “part(s)” or “%” denotes part(s) by mass or % by mass, unless otherwise stated.

### EXAMPLE 1

As for graphite particles, disc-shaped graphite particles having an aspect ratio of 1 to 10, prepared by using flaky natural graphite particles as raw material graphite, and pulverizing the flaky natural graphite particles by means of a vibration mill.

The graphite particles were analyzed by the following methods.

### (1) Specific Surface Area

The BET specific surface area was measured by means of a specific surface area measuring device (Gemini 2375, manufactured by Shimadze Corporation). The result was 9 m²/g.

As for the adsorbing agent, nitrogen was used, and the adsorption temperature was set to 77K.

### (2) X-Ray Crystallography

The graphite particles were measured by means of an X-ray diffraction spectrometer (RINT-UltimaIII, manufactured by Rigaku Corporation).

The obtained X-ray diffraction spectrum was analyzed to determine a crystal lattice constant (C0(002)) of (002) plane, the average interlayer distance d002, and a half value width of the (002) peak (peak appeared adjacent to 2theta=26.5 degrees).

The crystal lattice constant (C0(002)) was 0.672, and the half value width of the (002) peak was 0.299.

The measurement was performed using CuKα as a target, with 40 kV, and 200 mA.

Moreover, the peak of the rhombohedron (101-R) was appeared adjacent to 2theta=43.3 degrees, and the peak intensity thereof was determined as IB.

The peak of the hexagonal crystal (101-H) was appeared adjacent to 2theta=44.5 degrees, and the peak intensity thereof was determined as IA.

Then, a ratio IB/IA of the rhombohedronal structure present in the crystal structure was determined. As a result, the ratio IB/IA was 1.032.

### (3) Raman Spectroscopy

The graphite particles were measured by means of Raman spectrometer (laser Raman spectrometer NRS-3100, manufactured by JASCO Corporation).

The peak intensity ratio I(1360)/I(1580) of the peak intensity at 1,360 cm⁻¹ to the peak intensity at 1,580 cm⁻¹ in the Raman spectrum was determined. As a result, the peak intensity ratio was 0.34.

### (4) External Shape

The graphite particles were observed under an electron microscope manufactured by JEOL Ltd. to confirm external shapes of the graphite particles. As a result, the external shapes thereof were disc shapes.

### (5) Tap Density

A sample was placed in a 10 mL glass measuring cylinder, and tapped. When the volume of the sample stopped changing, the volume of the sample was measured. The value obtained by dividing the weight of the sample with the density of the sample was determined as the tap density. As a result, the tap density was 0.77 g/cm³.

Graphite-carbon composite particles for use were produced by the method explained below.

An outline of a device for producing the graphite-carbon composite particles is illustrated in FIG. 4. In FIG. 4, 1 is a sample, 2 is a furnace, 3 is a quartz tube, 4 is a flow meter, 5 is toluene, 6 is toluene gas, and 7 is N₂ gas.

In a cuvette formed of quartz placed inside a furnace heated to 1,100 degrees Celsius, the graphite particles were placed. To this, toluene vapor was introduced using argon gas as a carrier, to thereby precipitate and carbonize toluene on the graphite. The precipitation carbonization treatment was carried out for 3,600 seconds.

The obtained coated graphite was analyzed. As a result, there were a peak at 1,360 cm⁻¹ and a peak at 1,580 cm⁻¹ in the Raman spectrum, and the Raman peak intensity ratio I(1360)/I(1580) was 0.16.

A coverage rate was calculated by varying a weight. The coverage rate was 10% plus or minus 3%.

Moreover, crystallinity of the carbon covering layer was confirmed by NMR. Specifically, Li ions introduced into the natural graphite and the crystalline carbon have signals at 45 ppm and 10 ppm. The signal at 45 ppm indicates Li inserted into the natural graphite, and the signal at 10 ppm indicates Li inserted into the crystalline carbon. No signal at about 100 ppm, which was chemical shift observed when introduced into isotropic carbon, was observed. As a result, it was assumed that the carbon was crystalline.

### Production of Positive Electrode

By means of a non-bubbling kneader NBK1 (manufactured by NIHONSEIKI KAISHA LTD.), 3 g of the graphite-carbon composite particles produced in the aforementioned method, 1 g of activated carbon (product name: Maxsoap (registered trademark) MSP-20, manufactured by KANSAK COKE AND CHEMICALS CO., LTD., specific surface area: 2,000 m²/g, average particle diameter: 8 micrometers), and 4 g of an acetylene black (AB) solution (20% AB dispersed product, manufactured by MIKUNI COLOR LTD., H₂O solvent based solution where SA black model number: A1243 was diluted to give 5-fold dilution: 5%AB-H₂O) were kneaded for 15 minutes at 1,000 rpm.

Moreover, 1 g to 3 g of a 3% CMC aqueous solution was added to the resultant to adjust the conductivity and viscosity thereof.

The resulting kneaded product was shaped on a 18 micrometers-thick aluminum sheet by means of a film formation device, to thereby obtain a positive electrode.

### Non-Aqueous Electrolyte

As for a non-aqueous electrolyte, 0.3 mL of a solution, in which 1 mol/L of LiBF₄ was dissolved in an EC/PC solution [(mass ratio)=50/50, (manufactured by KISHIDA CHEMICAL Co., Ltd.)], was prepared.

### Separator

As for a separator, laboratory filter paper (ADVANTEC GA-100 GLASS FIBER FILTER) was provided.

### Production of Storage Element

A coin cell was produced using the positive electrode, Li, the electrolyte, and the separator, nu placing the positive electrode and negative electrode, both of which had been punched to give a diameter of 16 mm, adjacent to each other with the separator being placed between the positive electrode and the negative electrode in an argon dry box.

The coin cell was filled with 0.4 mL of the non-aqueous electrolyte to thereby produce a non-aqueous electrolyte storage element.

Various properties of the non-aqueous electrolyte storage element were investigated in the following manners.

### Charge-Discharge Behavior

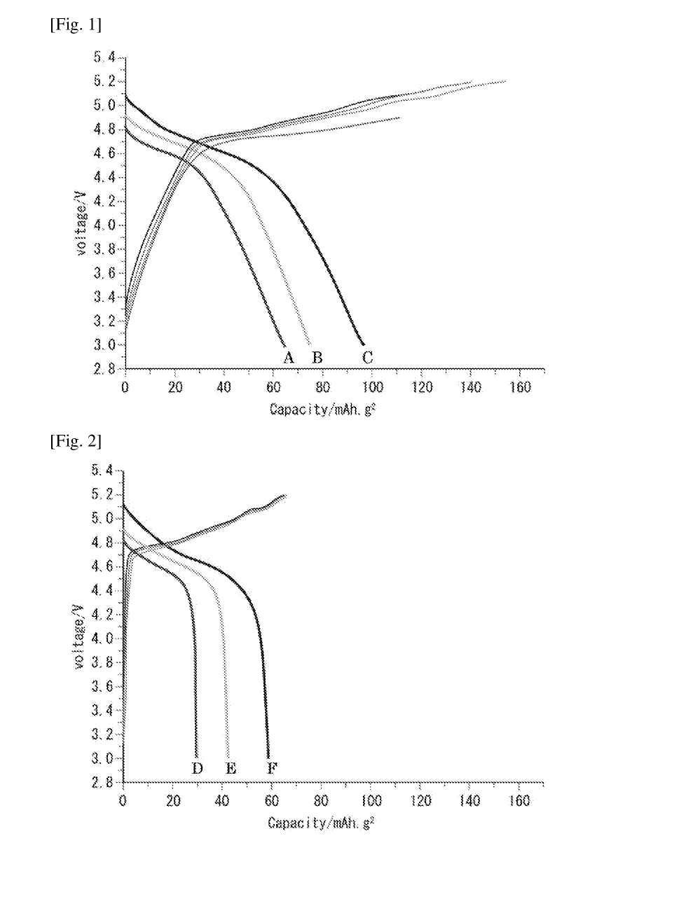

The storage element was charged to the charge termination voltage of 4.9 V, 5.0 V, or 5.2 V at room temperature by means of TOSCAT-3100 manufactured by TOYO SYSTEM CO., LTD. with constant electric current of 0.57 mA/cm². As a result, the discharge capacity increased, as the voltage increased, as depicted in FIG. 1. The capacity thereof achieved 95 mAh/g with the charge termination voltage of 5.2 V.

FIG. 1 depicts charging and discharging behaviors from 1st cycle to 9th cycle. Among these cycles, the charge-discharge curves were almost overlapped, and stable charging and discharging could be achieved.

In the case where LiPF₆ was added as a salt to the electrolyte in addition to LiBF₄, or the salt was replaced from LiBF₄ to LiPF₆ in Example 1, detachment of fluorine groups from PF₆ was observed, the cycling properties tend to degrade.

In the case where the flaky natural graphite particles were replaced with spherical graphite particles in Example 1, moreover, the discharge capacity was about 73 mAh/g with the charge of 5.2 V.

### COMPARATIVE EXAMPLE 1

A cell was produced in the same manner as in Example 1, provided that 1 g of the activated carbon (product name: Maxsoap (registered trademark) MSP-20, manufactured by KANSAK COKE AND CHEMICALS CO., LTD., specific surface area: 2,000 m²/g, average particle diameter: 8 micrometers) was not added, and the produced cell was measured in the same manner as in Example 1.

The obtained results are presented in FIG. 2.

As seen in FIG. 2, the discharge capacity was about 60 mAh/g, even when the cell was charged to 5.2 V, and an increase in the capacity could not be confirmed.

### COMPARATIVE EXAMPLE 2

A cell was produced in the same manner as in Example 1, provided that only the graphite particles were used without using the graphite-carbon composite particles, and the produced cell was measured in the same manner as in Example 1.

As a result, the discharge capacity was about 54 mAh/g, even when the cell was charged to 5.2 V, and an increase in the capacity could not be confirmed.

### COMPARATIVE EXAMPLE 3

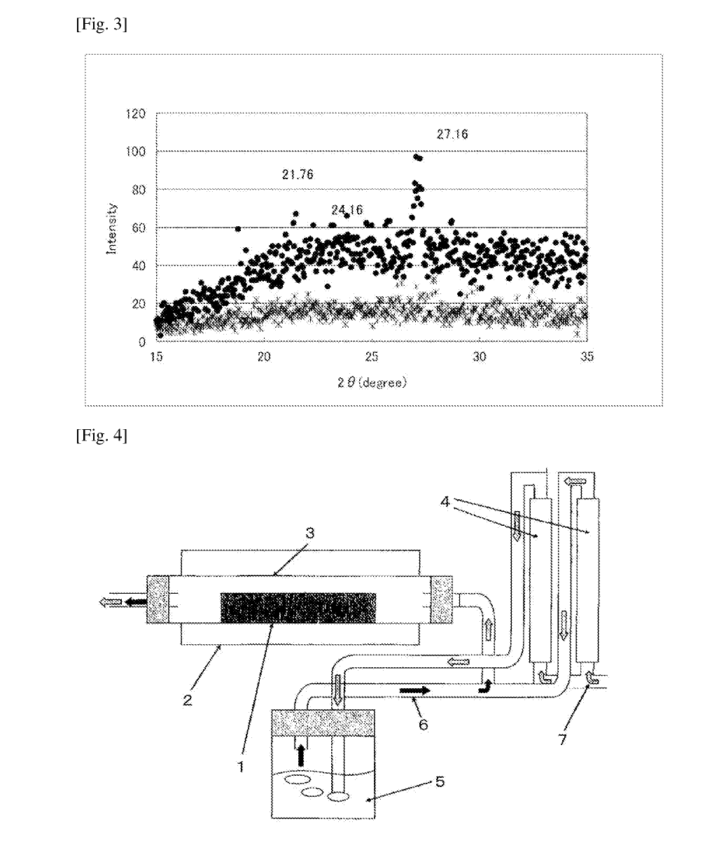

As a carboneous material, those having poor crystallinity, such as the one having no peak in the X-ray crystal analysis as depicted in FIG. 3, or the one exhibiting a signal at 100 ppm in the NMR measurement, were selected.

Note that, in FIG. 3, and x depict the results of two measurements.

A cell was produced in the same manner as in Example 1, provided that these carboneous materials were used. As a result, the discharge capacity was about 20 mAh/g, even when charged to 5.2 V, and an increase in the capacity could not be confirmed. It was assumed from above that it was difficult to even secure a capacity originally attained when the crystallinity was poor, specifically, intercalation to the crystalline carbon layer was also caused.

### EXAMPLE 2

### Production of Negative Electrode

By means of a non-bubbling kneader NBK1 (manufactured by NIHONSEIKI KAISHA LTD.), 3 g of lithium titanate (LTO, Li₄Ti₅O₁₂, manufactured by Titan Kogyo, Ltd.), and 4 g of an acetylene black solution (manufactured by MIKUNI COLOR LTD., a 5 fold-dilution solution of AB: 5% AB-H₂O) serving as a negative electrode material were kneaded for 15 minutes at 1,000 rpm.

Moreover, 1 g to 3 g of a 3% CMC aqueous solution was added to the resultant to adjust the conductivity and viscosity thereof.

The resulting kneaded product was shaped on a 18 micrometers-thick aluminum sheet by means of a film formation device, to thereby obtain a negative electrode. Other than that, a cell was produced in the same manner as in Example 1, and the produced cell was measured in the same manner as in Example 1, provided that the charge termination voltage was set to 3.7 V.

The obtained results were similar to those of Example 1, and an increase in the capacity was observed with the charge termination voltage of 3.7 V.

### EXAMPLE 3

Cells were produced in the same manner as in Example 1, provided that the ratio EC/PC (mass ratio) in the electrolyte was varied to 25/75, 20/80, 15/85, 10/90, and 5/95, and capacities thereof were compared. When EC was added by 5%, 10%, 15%, and 20% to 100% of the electrolyte, a change (reduction rate) of the capacity was 10% or less. However, the charge capacity of the cell reduced by about 30%, when EC was blended by 25%, and the cycle life of the cell was also shortened. It was assumed that this occurred because EC was also intercalated at the same time.

TABLE 1

| Proportion of PC | Capacity reduction rate (%) |
|---|---|
| 100 | 0 |
| 95 | 1 |
| 90 | 0 |
| 85 | 10 |
| 80 | 10 |
| 75 | 30 |

### EXAMPLE 4

A proportion of the activated carbon in the positive electrode active material, other than 25% by mass, which was discussed in Example 1, was studied. As a result, the most preferable proportion of the activated carbon in the entire positive electrode active material was about 25% by mass plus or minus 2% by mass.

When the proportion thereof was greater than 25% by mass, the bulkiness of the activated carbon adversely affected, and an increase in the capacity could not be confirmed when the activated carbon was added by 25% by mass or greater.

When the proportion of the activated carbon was less than 25% by mass, a degree of the increase in the capacity, which was observed in Example 1, could not be confirmed.

The embodiments of the present invention are, for example, as follows.

<1> A non-aqueous electrolyte storage element, containing:

a positive electrode;

a negative electrode; and

a non-aqueous electrolyte, wherein the positive electrode is an electrode, which contains: graphite-carbon composite particles composed of graphite particles and a carbon layer covering the graphite particles, and containing crystalline carbon; and activated carbon, and wherein the positive electrode is capable of accumulating and releasing anions.

<2> The non-aqueous electrolyte storage element according to <1>, wherein the graphite particles are scaly graphite particles.

<3> The non-aqueous electrolyte storage element according to <1> or <2>, wherein the negative electrode is an electrode capable of accumulating and releasing metal lithium, or lithium ions, or both.

<4> The non-aqueous electrolyte storage element according to any one of <1> to <3>, wherein the non-aqueous electrolyte is a non-aqueous electrolyte, in which a lithium salt is dissolved in a non-aqueous solvent.

<5> The non-aqueous electrolyte storage element according to <4>, wherein the lithium salt is LiBF₄.

<6> The non-aqueous electrolyte storage element according to any one of <1> to <5>, wherein the non-aqueous electrolyte contains propylene carbonate in an amount of 80% by mass or greater.

<7> The non-aqueous electrolyte storage element according to any one of <3> to <6>, wherein a negative electrode active material contains lithium titanate.

<8> The non-aqueous electrolyte storage element according to any one of <1> to <7>, wherein an amount of the activated carbon is 23% by mass to 27% by mass relative to a total amount of positive electrode active materials.

1: A non-aqueous electrolyte storage element, comprising:
a positive electrode;
a negative electrode; and
a non-aqueous electrolyte,
wherein the positive electrode comprises: graphite-carbon composite particles comprising graphite particles, a carbon layer covering the graphite particles, and crystalline carbon; and activated carbon, and
wherein the positive electrode is capable of accumulating and releasing anions.

2: The non-aqueous electrolyte storage element according to claim 1, wherein the graphite particles are scaly graphite particles.

3: The non-aqueous electrolyte storage clement according to claim 1, wherein the negative electrode is an electrode capable of accumulating and releasing metal lithium, or lithium ions, or both.

4: The non-aqueous electrolyte storage element according to claim 1, wherein the non-aqueous electrolyte is a non-aqueous electrolyte, in which a lithium salt is dissolved in a non-aqueous solvent.

5: The non-aqueous electrolyte storage element according to claim 4, wherein the lithium salt is LiBF₄.

6: The non-aqueous electrolyte storage element according to claim 1, wherein the non-aqueous electrolyte contains propylene carbonate in an amount of 80% by mass or greater.

7: The non-aqueous electrolyte storage element according to claim 3, wherein the negative electrode comprises a negative electrode active material containing lithium titanate.

8: The non-aqueous electrolyte storage element according to claim 1, wherein an amount of the activated carbon is 23% by mass to 27% by mass relative to a total amount of positive electrode active materials.
